(19) United States
(12) Patent Application Publication
(10) Pub. No.: US 2026/0118324 A1
(43) Pub. Date: Apr. 30, 2026

(54) SYSTEM EQUILIBRATION FOR AN ANALYSIS DEVICE

(71) Applicant: Agilent Technologies, Inc., Santa Clara, CA (US)

(72) Inventors: Timo Witte, Waldbronn (DE); Stefan Mittrich, Kapsweyer (DE); Benedikt Metzger, Waldbronn (DE); Markus Arendt, Waldbronn (DE); André Feith, Waldbronn (DE)

(21) Appl. No.: 19/370,308

(22) Filed: Oct. 27, 2025

(30) Foreign Application Priority Data
Oct. 28, 2024 (DE) 102024131315.3

(51) Int. Cl. G01N 30/30; G01N 30/02; G01N 30/22; G01N 30/32

(52) U.S. Cl. CPC G01N 30/30; G01N 30/22; G01N 30/32; G01N 2030/027; G01N 2030/324; G01N 2030/326

(57) ABSTRACT

A method for operating an analysis device, in particular a sample separation device, for performing an analysis includes setting a determined equilibrium value as a control value for a controlled variable of the analysis device, the equilibrium value having been determined in advance by controlling at least one control variable of the analysis device to a target value and determining the resulting equilibrium value of a controlled variable of the analysis device in response to the controlling of the at least one control variable. The method also includes controlling the at least one control variable to the target value such that the control value of the controlled variable is complied with in the process.

### CROSS-REFERENCE TO RELATED APPLICATIONS

The present application claims the benefit of German Patent Application No. DE 10 2024 131 315.3, filed on Oct. 28, 2024, which is incorporated herein by reference in its entirety.

### TECHNICAL FIELD

The present disclosure relates to a method for operating an analysis device that includes setting a determined equilibrium value as a control value for a controlled variable of the analysis device, the equilibrium value having been determined in advance by controlling at least one control variable of the analysis device to a target value and determining the resulting equilibrium value of the controlled variable of the analysis device in response to the controlling of the at least one control variable. The method also includes controlling the at least one control variable of the analysis device to the target value such that the control value of the controlled variable is complied with in the process. The present disclosure further relates to an analysis device having a control device configured to carry out the method.

### BACKGROUND

Analysis devices such as sample separation devices are provided for the analysis of a sample, in particular a fluidic sample, e.g. for carrying out a chromatographic separation of the sample. For example in an HPLC (high-performance liquid chromatography) analysis device, a liquid (mobile phase) is moved at a very precisely controlled flow rate (for example in the range of microliters to milliliters per minute) and at a high pressure (typically 20 to 1000 bar and above, currently up to 2000 bar), at which the compressibility of the liquid can be noticeable, through a so-called stationary phase (for example in a chromatographic column), in order to separate individual fractions of a sample liquid introduced into the mobile phase from one another. After passing through the stationary phase, the separated fractions of the fluidic sample are detected in a detector. Such an HPLC system is known for example from EP 0,309,596 B1 of the same applicant, Agilent Technologies, Inc., the entire contents of which are incorporated herein by reference.

In an analysis device, such as an HPLC, the switching between two states of an instrument can lead to the following problem: the pressure (of the flow) that is set must be set such that the separation column is not damaged. However, this pressure also depends on the temperature of the column, so that it must be ensured that a certain column temperature is reached before the target pressure/flow is applied.

FIG. 6 shows a conventional example of starting up a column oven (with chromatographic separation column). In this solution, the flow 110 is first increased to a value below the target flow (e.g. 50%), so that the pressure 120 remains lower until the target temperature 130 is reached. After the target temperature 130 is reached, the flow 110 can be increased to the target value. Thus, there is no pressure overload of the column, but the system can nevertheless increase flow and temperature at the same time.

Conventionally, the flow rate is increased only slowly or only increased when the target temperature has already been reached. However, this procedure can be very laborious and time-consuming, in particular over a relatively long period of time (respectively newly starting up the device) or in the case of a plurality of devices.

### SUMMARY

There may be a need to operate an analysis device efficiently, in particular with regard to system equilibration.

According to a first exemplary embodiment of the present disclosure, a method for operating an analysis device (in particular with regard to system equilibration) is described, the method comprising (in particular in a second process):
i) setting a (previously) determined equilibrium value (of a controlled variable of the analysis device) as a control value (in particular limit value) for a controlled variable (e.g. pressure, in particular back pressure) of the analysis device.

Here, the equilibrium value was determined in particular in advance (in particular in a first process which lies temporally before the second process) by controlling (allowing to increase, ramping up) at least one control variable (e.g. flow rate and/or temperature) of the analysis device to a target value, and determining the resulting equilibrium value of the controlled variable of the analysis device in response to the controlling of the at least one control variable (in other words: determining an equilibrium pressure which occurs when the flow rate/temperature has/have reached its target value).
ii) controlling the at least one control variable of the analysis device to the target value such that the control value of the controlled variable is complied with in the process (or this limit value is not exceeded).

According to a second exemplary embodiment of the present disclosure, an analysis device is described which comprises a control device configured to carry out the method described above.

In the context of the present document, the term “control variable” may denote in particular a parameter of an analysis device which can be controlled directly. In a first example, the control variable is a temperature of a thermostat and/or of a mobile phase. The temperature can be controlled in a targeted manner to a certain value, e.g. with corresponding heating elements. In a second example, the control variable is a flow rate of the mobile phase. The flow rate can be controlled in a targeted manner to a certain value, e.g. with an analytical pump. When starting/starting up the analysis device (before the actual analysis), e.g. the temperature and the flow rate can be increased. Before the desired target value is reached, the control variable is increased or controlled along a slope phase towards the target value. A control variable in the present context can thus be denoted as a directly adjustable parameter and/or an acting parameter.

In the context of the present document, the term “controlled variable” may denote in particular a parameter of an analysis device which is not controlled directly or cannot be controlled directly. Instead, the controlled variable results from the controlling/adjusting of one or more control variables. The controlled variable is thus an indirectly adjustable parameter or a parameter which is adjustable by controlling the corresponding control variable(s). In other words, the controlled variable can be understood as a reacting parameter with respect to the control variable as an acting parameter. In an exemplary embodiment, the controlled variable may be a pressure, in particular a back pressure, which is established (e.g. at the separation column when mobile phase is flowed in under high pressure and before the end of the temperature control) depending on the flow rate of the mobile phase and/or the temperature (as control variable(s)).

In the context of the present document, the term “equilibrium value” is understood as a state in which a parameter remains stable over time, in particular has reached an equilibrium state (with respect to the other parameters). After a rise phase of a parameter, a maintenance phase may occur, in which the parameter then remains stable. If at least one control variable and one controlled variable are present, there is a dependence between these parameters and an equilibrium state is established after some time between the parameters. The controlled variable is not controlled directly, so that the adjustment of the equilibrium state of the controlled variable is dependent on one or more control variables. The equilibrium value is then the value of the controlled variable (e.g. a certain pressure), which is established when the equilibrium state of the system is reached.

In the context of the present document, the term “control value” is understood as a physical variable to which the controlled variable is to be adjusted, or the control value is to specify a target value for the controlled variable. In one example, the (once determined) equilibrium value of the controlled variable may be used as a control value for a plurality of system equilibrations. In this case, the one or more control variables are controlled such that the control value of the controlled variable is reached (indirectly via the control variables), in particular is not exceeded.

In the context of the present document, the term “fluid” is understood in particular as a liquid and/or a gas, optionally comprising solid particles. The term “fluid” may also relate to a mobile phase in which a fluidic sample is transported.

In the context of the present document, the term “fluidic sample” is understood in particular as a medium, further in particular a liquid, which contains the matter actually to be analyzed (for example a biological sample), such as for example a protein solution, a pharmaceutical sample, etc.

In the context of the present document, the term “mobile phase” is understood in particular as a fluid, further in particular a liquid, which serves as a carrier medium for transporting the fluidic sample between a fluid drive and a sample separation unit. Mobile phase may, however, also be used in a fluid conveying device for influencing the fluidic sample. For example, the mobile phase may be a (for example organic and/or inorganic) solvent or a solvent composition (for example water and ethanol).

In the context of the present document, the term “analysis device” may denote in particular a device which is able and configured to examine, in particular to separate, a fluidic sample, further in particular to separate it into different fractions. For example, such a sample separation may take place by means of chromatography or electrophoresis. The analysis device may be a liquid chromatography sample separation device.

According to an exemplary embodiment, the present disclosure may be based on the idea that an analysis device may be operated (or started up) in an efficient manner if firstly an equilibrium value is determined for a controlled variable, at which the controlled variable adjusts to an equilibrium with respect to one or more control variable(s), and subsequently this equilibrium value is used as a control value for the controlled variable, so that controlling the control variable(s) does not exceed the control value of the controlled variable.

In other words, the operation may be optimized by taking into account observations/measurements from an earlier run of the same method. As a result, the time required for starting up the analysis device or for adjusting an equilibrium state (system equilibration) may be significantly reduced. Required resources such as solvents for the mobile phase may also be saved.

In a specific embodiment of an HPLC, it has hitherto been necessary (cf. FIG. 6), in order to make the HPLC system operational, to compensate the separation column by heating, applying a solvent flow and waiting for the stabilization of the conditions. In this case, certain boundary conditions, such as maximum back pressure of the separation column, must not be exceeded, since this could damage the system (in particular the separation column). However, the back pressure when the system is “balanced out” (column heated and pressure stabilized) is not known in advance. The back pressure depends on the temperature of the separation column used, so that it is usually necessary to wait until the separation column has heated before a flow may be applied or the flow rate is increased. Carrying out this system equilibration is necessary each time the system is switched on; as described above, this is time-consuming and also material-consuming.

It has now been recognized by the inventors that a significant saving of time and material (in particular solvent) can be achieved when the back pressure in the stable state (equilibrium value) is known in advance and the maximum pressure which the analytical pump delivers via the flow rate is limited to this value as a control value. It can thereby be ensured that the boundary conditions of the separation column are complied with, but the run time is optimized, and the flow of the mobile phase may be applied while the separation column is heated (in parallel).

In the following embodiments of the same method, the determined equilibrium value (e.g. back pressure value) can be used as a maximum control value, e.g. as a maximum value of the flow rate which the analytical pump delivers while the separation column is still heating. As a result, the time and the solvent which are required in order to reach a balanced-out state can be reduced while the back pressure is always kept in acceptable ranges.

### EXEMPLARY EMBODIMENTS

According to an exemplary embodiment, the method further comprises (in a preceding first process): controlling the at least one control variable of the analysis device to the target value, and determining the resulting equilibrium value of the controlled variable of the analysis device in response to the (or depending on the) controlling of the at least one control variable. The first process (experimental or also modeled) can thus provide the equilibrium value of the controlled variable which is established when the control variable(s) has reached its target value. The equilibrium value may serve as a target value or limit value for the controlled variable in a plurality of subsequent system equilibrations (in particular during start-up).

According to an exemplary embodiment, the at least one control variable comprises at least one of the following: a flow rate, a temperature, an electrical conductivity, a pressure, a (in particular adjustable) restriction. Accordingly, a plurality of control variables which may be relevant for the operation of analysis devices can be used directly. For example, a composition of the mobile phase can be determined via the electrical conductivity and the electrical conductivity may have an influence on the development of the controlled variable. An adjustable restriction (e.g. a backpressure regulator) can likewise be selected as a control variable.

In the case of the temperature, a distinction can be made in one example between the temperature of the column/of the oven and the (separately adjustable) temperature of the mobile phase.

Furthermore, the viscosity of the mobile phase may also have an influence on the controlled variable or the configuration of the separation column as such (e.g. length, packing material). Although these variables cannot be actively controlled during the equilibration process, for example the mobile phase and/or the separation column could be selected with regard to efficient equilibration. For example, the composition of the mobile phase for the equilibration process can be selected such that the viscosity corresponds to the maximum viscosity of the method (e.g. for a gradient).

According to one exemplary embodiment, the control value (of the controlled variable) comprises a limit value. Accordingly, the equilibrium value (from the first process) can be set as a limit value (or maximum value) for the controlled variable which must not be exceeded. The control variable(s) is/are therefore increased such that the limit value of the controlled variable is not exceeded in response.

According to one exemplary embodiment, the controlled variable comprises at least one of the following: a pressure, in particular a back pressure, a flow rate, a temperature, an electrical conductivity. Accordingly, a plurality of controlled variables which may be relevant for the operation of analysis devices can be used directly. In particular, the pressure in the context of an HPLC can be an especially relevant controlled variable because a lack of equilibration can lead to pressure peaks (see FIG. 6) which can possibly irreversibly damage device components, in particular the separation column.

According to one exemplary embodiment, the at least one control variable comprises a directly adjustable parameter and/or an acting parameter. According to an exemplary embodiment, the controlled variable comprises a parameter which is indirectly adjustable with respect to the control variable and/or a reacting parameter.

According to an exemplary embodiment, the at least one control variable comprises a first control variable, in particular a flow rate. According to an exemplary embodiment, the at least one control variable comprises a second control variable, in particular a temperature. According to an exemplary embodiment, the first control variable and the second control variable are associated with one another, in particular they interact with one another. According to an exemplary embodiment, the first control variable and/or the second control variable are associated with the controlled variable, in particular they interact.

According to an exemplary embodiment, the control of the first control variable and the control of the second control variable begin (substantially) at the same time (at the same/comparable time, without time delay). This takes place in particular in the second process. With the determined equilibrium value of the controlled variable as a control value, two or more control variables may be increased at the same time, whereby time and resources may be saved.

According to an exemplary embodiment, the control of the first control variable and the control of the second control variable may also begin (substantially) at the same time in the first process (cf. FIGS. 4 and 5). In this case, two or more slope phases (and corresponding maintaining phases) may be used for at least one of the control variables.

According to an exemplary embodiment, the beginning of the control of the second control variable lies temporally before the beginning of the control of the first control variable (temporally offset slope phases), this taking place in particular in the first process. According to an exemplary embodiment, the control of the first control variable begins (is started) after the second control variable has reached its target value, in particular in the first process. If no equilibrium value is (yet) known for the controlled variable, a time-offset increase in the control variables may be preferable for reasons of operational safety (cf. FIG. 6).

According to an exemplary embodiment, the control of the control variable comprises (at least) one slope phase until the target value is reached. According to an exemplary embodiment, an increase of the controlled variable in response to the controlling of the at least one control variable comprises at least one slope phase until the equilibrium value and/or the control value is reached.

According to an exemplary embodiment, the control of the control variable comprises at least two slope phases and at least one intermediate maintaining phase (equilibration phase) until the target value is reached. According to an exemplary embodiment, the control of the first control variable comprises more slope phases than the control of the second control variable (or vice versa). For example, the increase in one control variable comprises only one slope phase, while the increase in the other control variable comprises two or more slope phases (and corresponding maintaining phases in between).

According to an exemplary embodiment, the increase of the controlled variable in response to the controlling of the at least one control variable comprises at least two slope phases and at least one intermediate maintaining phase until the equilibrium value and/or the control value is reached.

According to an exemplary embodiment, the slope phases of the first control variable are adapted to a (the one) slope phase of the second control variable, in particular dynamically. According to an exemplary embodiment, the slope phases of the first control variable are selected such that the first control variable reaches its target value only when the second control variable has reached its target value.

According to an exemplary embodiment, the method further comprises: (in the first process): setting a maximum value (e.g. maximum pressure) for the controlled variable. The operational safety can thereby be increased. According to an exemplary embodiment, the method further comprises (in the second process): setting the control value of the controlled variable to the maximum value when the target value of the at least one control variable is reached. After adjusting the system equilibrium, a limit value of the controlled variable can be set to a maximum value again.

According to an exemplary embodiment, the first process and/or the second process comprise at least one of the following with respect to the analysis device: a starting process, a start-up, a system equilibration, an equilibration of a thermostat (or a sample separation apparatus), an equilibration of the separation column, an adjustment of an equilibrium state.

According to an exemplary embodiment, the first process is carried out experimentally and/or is simulated/modeled. While an experimental determination of the equilibrium value can be more reliable (realistic), a simulation/modeling of this equilibrium value could be more cost-effective/faster.

According to an exemplary embodiment, the first process serves as a reference. According to an exemplary embodiment, a plurality of second processes is carried out based on the first process as a reference. The once determined equilibrium value can thus be used further efficiently or (easily) adapted for a plurality of further system equilibrations.

According to an exemplary embodiment, the method is used for starting up the analysis device, in particular a thermostat of the analysis device. As described above, an embodiment may concern an equilibration (reaching the equilibration state) of the thermostat and/or the sample separation apparatus.

According to an exemplary embodiment, the analysis device comprises a thermostat, in particular a column oven, further in particular with at least one chromatographic separation column. According to an exemplary embodiment, the first control variable comprises a flow rate of a fluid, in particular of a mobile phase, into the thermostat, in particular into the chromatographic separation column. According to an exemplary embodiment, the second control variable comprises the temperature of the thermostat and/or of the mobile phase. According to an exemplary embodiment, the controlled variable comprises the back pressure, in particular at the chromatographic separation column, in response to the fluid flow, in particular with increasing temperature.

According to an exemplary embodiment, if parameters change (e.g. target flow rate, maximum pressure, composition), the determined equilibrium value can be adapted or reset.

According to an exemplary embodiment, the disclosure relates to the starting behavior of an HPLC and in particular to the control of the flow rate before reaching a target temperature. One or more flow rate stages can be determined from the existing temperature difference (target temperature-starting temperature); between an original/existing flow rate (typically zero) and the desired target flow rate.

In an exemplary embodiment, in order to avoid the exceeding of the high-pressure limit value (cf. FIG. 6), a stepwise flow ramp is applied (slope phases and maintaining phases). The steps depend e.g. on the course of the temperature ramp. In this case, the flow rate changes every 25% of the temperature delta by 25% of the target flow rate. Depending on the initial temperature delta T (starting temperature to target temperature), the step can be automatically defined to be smaller or larger. Furthermore, the flow changes (stages) can be controlled by the pressure-controlled flow ramp (bar/sec) (cf. FIGS. 4 and 5).

In an embodiment of determining the pressure of a certain method at a target flow rate and temperature (first step of a two-stage approach), the flow is not increased before the target temperature has been reached.

In an exemplary embodiment, the flow is increased from the beginning (i.e. together with the increase of the temperature), in particular in the first process. Instead of increasing the flow continuously (without additional limit values or control parameters) and thus taking the risk of damaging the column, the flow is increased stepwise depending on the current temperature value relative to the target temperature value (cf. FIGS. 4 and 5). This approach can encompass two or more flow ramping steps (flow ramp sections, slope phases). Alternatively, the flow can be increased until a low-pressure limit is reached, which lies e.g. 20% of an adjustable maximum pressure and in any case below a maximum pressure of the respective column.

In an exemplary embodiment, the flow is increased by the condition of delta P/delta T <x, wherein x is the acceptable pressure change within a certain period of time, so that the slope of the pressure curve is kept at a value, so that the maximum pressure is not reached before the target temperature.

In the context of the present application, the term “sample separation unit” can be understood in particular as a device for analyzing a fluidic sample, in particular into different fractions. For this purpose, constituents of the fluidic sample can first be adsorbed at the sample separation unit and then desorbed separately (in particular fractionally). For example, such a sample separation unit can be configured as a chromatographic separation column.

According to an exemplary embodiment, the analysis device is a sample separation device, in particular a chromatography device, in particular a liquid chromatography device, a gas chromatography device, an SFC (supercritical liquid chromatography) device or an HPLC (high-performance liquid chromatography) device.

According to an exemplary embodiment, the analysis device is configured as a microfluidic device. According to an exemplary embodiment, the analysis device is configured as a nanofluidic device.

According to an exemplary embodiment, the sample separation unit is configured as a chromatographic separation unit, in particular as a chromatographic separation column.

According to an exemplary embodiment, the fluid drive is configured for driving the mobile phase and the fluidic sample under high pressure.

According to an exemplary embodiment, the fluid drive is configured for driving the mobile phase and the fluidic sample at a pressure of at least 500 bar, in particular of at least 1000 bar, further in particular of at least 1200 bar, further in particular of at least 1500 bar.

According to an exemplary embodiment, the analysis device comprises a detector for detecting the analyzed, in particular separated, fluidic sample.

According to an exemplary embodiment, the analysis device comprises a fractionator for fractionating separated fractions of the fluidic sample.

The analysis device can be a microfluidic measuring device, a life science device, a liquid chromatography device, a gas chromatography device, an HPLC (high-performance liquid chromatography), a UHPLC plant or an SFC (supercritical liquid chromatography) device. However, many other applications are possible.

According to an exemplary embodiment, the sample separation unit can be configured as a chromatographic separation unit, in particular as a chromatographic separation column. In the case of a chromatographic separation, the chromatographic separation column can be provided with an adsorption medium. The fluidic sample can be held on this and only subsequently it may be fractionally detached again in the presence of a specific solvent composition, whereby the separation of the sample into its fractions is accomplished.

A pumping system for conveying fluid can be configured, for example, to convey the fluid or the mobile phase through the system at a high pressure, for example a few 100 bar up to 1000 bar and more.

The analysis device may comprise a sample injector for introducing the sample into the fluidic separation path. Such a sample injector may comprise a sample or injection needle which can be coupled to a needle seat in a corresponding liquid path, wherein the sample needle can be moved out of this needle seat in order to receive sample. After the reintroduction of the sample needle into the needle seat, the sample can be located in a fluid path which can be switched into the separation path of the system, for example by switching a valve. In another exemplary embodiment of the present disclosure, a sample injector or sampler with a sample needle which is operated without a needle seat can be used.

The analysis device may comprise a fraction collector for collecting the separated components. Such a fraction collector can guide the different components of the separated sample into different liquid containers, for example. However, the analyzed sample can also be fed to a drain container.

The analysis device may comprise a detector for detecting the separated components. Such a detector can generate a signal which can be observed and/or recorded and which is indicative of the presence and quantity of the sample components in the fluid flowing through the system.

In an exemplary embodiment, a viscosity/gradient (change in composition over time) can be used. Instead of “starting up” (or “booting up”) the system (and the temperature), the procedure could also make a “transfer” from one method to another. In this case, a change in composition can be carried out, which can lead to a different back pressure depending on the solvent. For example, a direct jump from composition A to composition B can lead to an identical behavior (pressure moves at the maximum pressure limit). Thus, a transition can first be made with a slow gradient in order to find out the target pressure at the end.

Embodiments of the present disclosure may be partly or entirely embodied or supported by one or more suitable software programs or products (or software), which may be stored on or otherwise provided by any kind of non-transitory medium or data carrier, and which may be executed in or by any suitable data processing unit such as an electronic processor-based computing device (or system controller, control unit, etc.) that includes one or more electronic processors and memories. Software programs or routines (e.g., computer-executable or machine-executable instructions or code) may be applied in or by the control unit, e.g. a data processing system such as a computer, such as for executing any of the methods described herein. For example, one embodiment of the present disclosure provides a non-transitory computer-readable medium that includes instructions stored thereon, such that when executed on a processor, the instructions perform or control one or more of the steps of the method of any of the embodiments disclosed herein.

### BRIEF DESCRIPTION OF THE DRAWINGS

Other objects and many of the attendant advantages of exemplary embodiments of the present disclosure will become readily apparent and better understood by reference to the following more detailed description of exemplary embodiments in conjunction with the accompanying drawings. Features which are substantially or functionally identical or similar are provided with the same reference signs.

FIG. 1 shows an analysis device configured as a sample separation device with a thermostat, according to an exemplary embodiment of the present disclosure.

FIG. 2 shows a first process of determining a resulting equilibrium value of a controlled variable in response to the controlling of a control variable, according to an exemplary embodiment of the present disclosure.

FIG. 3 shows a second process of controlling the control variable to a target value such that the equilibrium value determined in the first process is complied with in the process as a control value of the controlled variable, according to an exemplary embodiment of the present disclosure.

FIG. 4 shows an example of the first process, wherein the control variable is controlled stepwise, according to an exemplary embodiment of the present disclosure.

FIG. 5 shows another example of the first process, wherein the control variable is controlled stepwise, according to an exemplary embodiment of the present disclosure.

FIG. 6 shows a conventional starting up of the column oven, wherein the back pressure of the column increases too fast.

The illustrations in the drawings are schematic.

### DETAILED DESCRIPTION

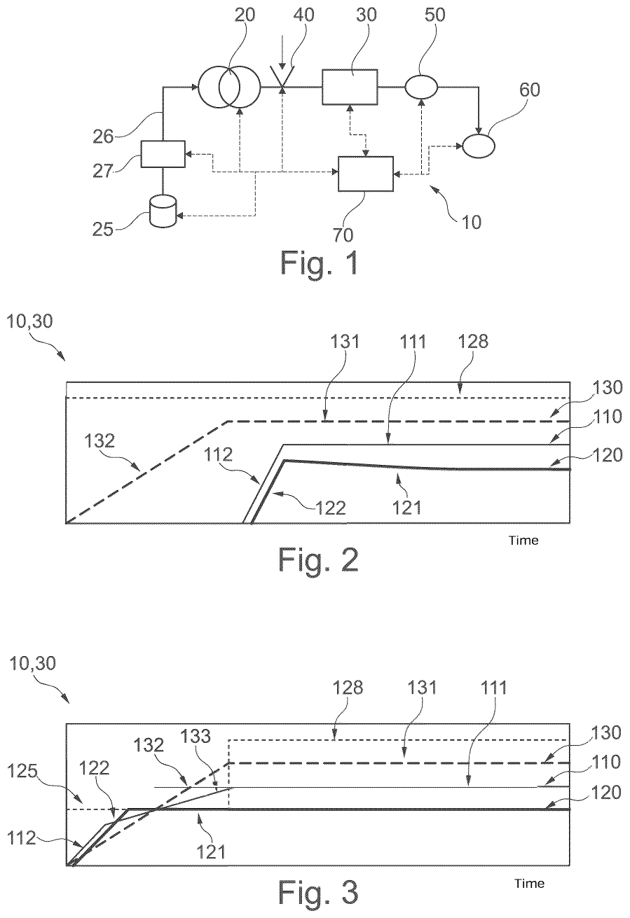

FIG. 1 shows the basic structure of an HPLC system as an example of an analysis device 10 configured as a sample separation device according to an exemplary embodiment of the present disclosure, as can be used for example for liquid chromatography. A fluid conveying device or a fluid drive 20 (such as an analytical pump), which is supplied with solvents from a supply device 25, drives a mobile phase through a sample separation apparatus 30 with a sample separation unit (such as, for example, a chromatographic column), which contains a stationary phase. The sample separation apparatus 30 may comprise a thermostat or column oven, in which the chromatographic separation column is arranged.

The supply device 25 encompasses a first fluid component source for providing a first fluid or a first solvent component A (for example water) and a second fluid component source for providing another second fluid or a second solvent component B (for example an organic solvent). An optional degasser 27 can degas the solvents provided by means of the first fluid component source and by means of the second fluid component source before they are fed to the fluid drive 20. Optionally, the solvents can be mixed at a mixing point.

A sample feed unit, which can also be referred to as injector 40, is arranged between the fluid drive 20 and the sample separation apparatus 30 in order to initially receive a sample liquid or a fluidic sample from a sample container into a sample receiving volume in an injector path, and subsequently introduce it into a fluidic separation path between fluid drive 20 and sample separation apparatus 30 by switching an injection valve of the injector 40. The receiving of fluidic sample from the sample container can take place, in particular, in that a sample needle is moved out of a sample seat and moved into the sample container, fluidic sample is sucked out of the sample container through the sample needle into the sample receiving volume by means of a fluid conveying device configured as a metering unit, and the sample needle is then moved back into the needle seat.

The stationary phase of the sample separation device is provided for the purpose of separating components of the sample. A detector 50, which may comprise a flow cell, detects separated components of the sample. A fractionation device or fractionator 60 can be provided for the purpose of outputting separated components of the sample into containers provided for this purpose. Liquids which are no longer required can be output into a drain container or into a waste line.

While a liquid path between the fluid drive 20 and the sample separation device 30 is typically under high pressure, the sample liquid is initially introduced under normal pressure into a region which is separated from the liquid path, namely the sample loop or the sample receiving volume of the sample feed unit or injector 40. The sample liquid is then introduced into the separation path which is under high pressure. A sample loop as sample receiving volume can be understood as a section of a fluid line that is configured for receiving or temporarily storing a predefined quantity of fluidic sample. In an embodiment, even before the sample liquid which is initially under normal pressure in the sample receiving volume is switched into the separation path which is under high pressure, the content of the sample receiving volume is brought to the system pressure of the analysis device 10 configured as an HPLC by means of a metering unit in the form of the fluid conveying device.

A control unit 70 controls the individual components 20, 25, 30, 40, 50, 60, etc., of the analysis device 10. In an exemplary embodiment, the thermostat of the sample separation apparatus 30 is controlled or started up as described in detail below.

FIG. 2 shows a first process of determining a resulting equilibrium value 121 of a controlled variable in response to the controlling of at least one control variable 110, 130, according to an exemplary embodiment of the present disclosure.

In this example, a flow rate is used as a first control variable 110 and a temperature is used as a second control variable 130. The flow rate relates to a flow of the mobile phase (with or without fluidic sample) from the analytical pump 20 through the sample separation unit or separation column of the sample separation apparatus 30. The temperature relates to the temperature in the thermostat 30 or column oven, in which the sample separation unit is arranged and temperature-controlled. In this example, the controlled variable 120 is a pressure (or back pressure) that builds up when the mobile phase is flowed or pressed into the sample separation unit under high pressure. While the control variables 110, 130 are controlled directly (the flow rate 110 or the temperature 130 are adjusted directly), the controlled variable 120 is not controlled, but results in response to the control variables 110, 130 or is dependent thereon. In other words, the back pressure is the result of the adjusted control variables flow rate and temperature.

In FIG. 2, the first control variable 110 (flow rate), the second control variable 130 (temperature), and the controlled variable 120 (pressure) are represented schematically and without units in the course of time for reasons of better clarity. The X-axis thus shows the time (random unit) and the Y-axis shows the intensity (random units) of the control/controlled variables.

The first control variable 110 and the second control variable 130 are associated with one another and interact with one another. The controlled variable 120 is also associated with the control variables 110, 130 and interacts therewith.

First, the heating-up of the thermostat 30 begins: the second control variable 130 (temperature) is increased along a slope phase 132 to a target value 131 (e.g. the desired measurement temperature). When the target value 131 has stabilized (maintaining phase, no slope or gradient), the flow of the mobile phase is started and the first control variable 110 (flow rate) is slowly increased along a slope phase 112 up to a desired target value 111 (e.g. the flow rate for a measurement). In other words, the first control variable 110 is controlled to the target value 111.

When the flow rate 110 increases, a back pressure 120 builds up at the sample separation unit after a short time delay. Depending on the flow rate 110 and the temperature 130, the pressure is now established as controlled variable 120. In response to the increasing flow rate 110, the pressure 120 increases during a slope phase 122 until it settles to an equilibrium value 121. The reaching of the equilibrium value 121 is dependent on the fact that the first control variable 110 and the second control variable 130 have likewise stabilized at their respective target value 111, 131.

In the example shown, a maximum value 128 (or maximum pressure) is defined for the controlled variable 120. However, this lies far above the pressure 120 actually present. The resulting equilibrium value 121 of the controlled variable 120 (under certain conditions of the flow rate and the temperature) can now be determined and used as a control value 125, in particular limit value, (input parameter) for further subsequent processes.

FIG. 3 shows a second process (which follows the first process described above) of controlling the at least one control variable 110, 130 to a target value 111, 131 such that the equilibrium value 121 of the controlled variable determined in the first process is complied with in the process as a control value 125 of the controlled variable, according to an exemplary embodiment of the present disclosure.

The determined equilibrium value 121 is thus set as a control value 125 (in this example also as a limit value) for the controlled variable 120, wherein the equilibrium value 121 was determined in advance (in the first process described above) by controlling at least one control variable 110, 130 to a target value 111, 131, and determining the resulting equilibrium value 121 of the controlled variable 120 in response to the controlling of the at least one control variable 110, 130.

If the first control variable 110 and the second control variable 130 are now controlled to the respective target value 111, 131, the control value 125 of the controlled variable 120 is complied with in the process. In other words, the controlled variable must not exceed the limit value predefined by the control value 125. Because the control value 125 of the controlled variable 120 (or the back pressure resulting at an equilibrium) is known, the two control variables 110, 130 can be increased significantly faster. Furthermore, the increase in flow rate 110 and temperature 130 can also be started (substantially) at the same time. In contrast thereto, it was still necessary to wait in the first process (see above) until the temperature 130 had stabilized before the flow rate 110 could be adjusted. Accordingly, a significant time saving with the same/higher reliability can be provided. Solvents (mobile phase) may also be saved with a shorter equilibration time.

FIG. 3 shows that the controlled variable 120 reaches the control value 125 relatively fast and is then kept there (maintaining phase). When the control variable 130 has then stabilized to the target value 131, the control value 125 of the controlled variable 120 can be replaced again by the maximum value 128 (see above). The flow 110 may change here depending on the equilibrium value 121 and/or the control value 125 (the flow 110 continues to increase while the control value 125 is active).

The first process and the second process may be, for example, system equilibration (in particular with regard to the sample separation device 30) of the analysis device 10 described above.

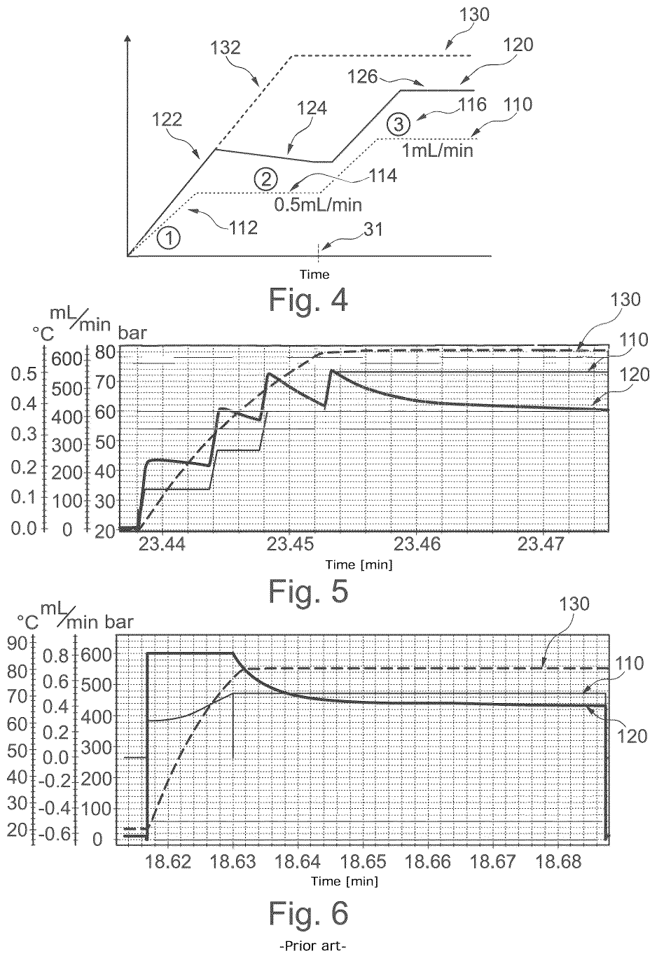

FIGS. 4 and 5 each show the first process, wherein a respective control variable 110, 130 is controlled stepwise, according to exemplary embodiments of the present disclosure.

FIG. 4: in this example, the second control variable 130 is increased as described for FIG. 2 along a slope phase 132 up to a target value 131. However, the first control variable 110 is increased by means of two different slope phases. First, the flow rate 110 is increased along the first slope phase. When a flow rate of 0.5 mL/min is reached (in this example), first an equilibration is waited for (maintaining phase 114). Thereafter, the flow rate is increased during a second slope phase until a flow rate of 1 mL/min is reached. Here, a further equilibration (maintaining phase 116) is waited which then leads to the stabilized target value 111.

It can be seen from FIG. 4 that the controlled variable 120 follows the control variable 110 and after the first slope phase 122 likewise comprises two equilibration phases (maintaining phases 124, 126) until the equilibrium value 121 is reached which can then be used as a control value 125 for the second process. A time at which the thermostat 30 can be regarded as ready for use is indicated by reference sign 31. This state is already reached in the first equilibration in this example.

FIG. 5: this example shows a similar situation to FIG. 4, wherein the first control variable 110 comprises four slope phases and four equilibration phases. The controlled variable 120 follows these phases, wherein with increasing flow rate 110 (and temperature 130) the reaching of the equilibrium state of the pressure is made more difficult or a greater drop/gradient can be observed.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the control unit 70 schematically depicted in FIG. 1. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein that, when executed by a processing module of an electronic system (e.g., the control unit 70 schematically depicted in FIG. 1), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

### REFERENCE SIGNS

10 Analysis device
20 Fluid drive
25 Supply device
27 Degasser
30 Sample separation unit, thermostat/column oven
31 Status change thermostat
40 Injector
50 Detector
60 Fractionator
70 Control unit, control device
110 Control variable, first control variable
111 Target value, first target value
112 Slope phase, first control variable
113 Further slope phase, first control variable
114 First maintenance phase, first control variable
116 Second maintenance phase, first control variable
120 controlled variable
121 equilibrium value
122 Slope phase, controlled variable
124 First maintenance phase controlled variable
125 Control value, limit value
126 Second maintenance phase controlled variable
128 maximum value
130 Second control variable
131 Second target value
132 Slope phase, second control variable

1. A method for operating an analysis device, the method comprising:
a second process comprising:
setting a determined equilibrium value as a control value for a controlled variable of the analysis device,
wherein the equilibrium value was determined in advance by controlling at least one control variable of the analysis device to a target value, and determining the resulting equilibrium value of the controlled variable of the analysis device in response to the controlling of the at least one control variable; and
controlling the at least one control variable of the analysis device to the target value such that the control value of the controlled variable is complied with in the process.

2. The method according to claim 1, further comprising:
in a first process preceding the second process:
controlling the at least one control variable of the analysis device to the target value; and
determining the resulting equilibrium value of the controlled variable of the analysis device in response to the controlling of the at least one control variable.

3. The method according to claim 1, wherein the at least one control variable comprises at least one of the following: a flow rate; a temperature; an electrical conductivity; a pressure; a restriction.

4. The method according to claim 1, wherein the control value comprises a limit value.

5. The method according to claim 1, wherein the controlled variable comprises at least one of the following: a pressure; a back pressure; a flow rate; a temperature; an electrical conductivity.

6. The method according to claim 1, wherein the at least one control variable comprises a directly adjustable parameter and/or an acting parameter, and the controlled variable comprises a parameter which is indirectly adjustable with respect to the control variable and/or a reacting parameter.

7. The method according to claim 1, wherein the at least one control variable comprises a first control variable and a second control variable, and
wherein the first control variable and the second control variable are associated with one another and/or interact with one another; and/or
wherein the first control variable and the second control variable are associated and/or interact with the controlled variable.

8. The method according to claim 1, wherein the control of the first control variable and the control of the second control variable begin substantially at the same time in the second process.

9. The method according to claim 1, wherein the beginning of the control of the second control variable lies temporally before the beginning of the control of the first control variable in the first process.

10. The method according claim 1, wherein the control of the first control variable begins after the second control variable has reached its target value in the first process.

11. The method according to claim 1, wherein:
the control of the control variable comprises at least one slope phase until the target value is reached; and/or
an increase of the controlled variable in response to the controlling of the at least one control variable comprises at least one slope phase until the equilibrium value and/or the control value is reached.

12. The method according to claim 1, comprising at least one of the following features:
wherein the controlling of the control variable comprises at least two slope phases and at least one intermediate maintaining phase until the target value is reached;
wherein the controlling of the first control variable comprises more slope phases than the controlling of the second control variable;
wherein the increase of the controlled variable in response to the controlling of the at least one control variable comprises at least two slope phases and at least one intermediate maintaining phase until the equilibrium value and/or the control value is reached.

13. The method according to claim 1,
wherein the slope phases of the first control variable are adapted to the slope of the second control variable dynamically; and/or
wherein the slope phases of the first control variable are selected such that the first control variable reaches its target value only when the second control variable has reached its target value.

14. The method according to claim 1, further comprising:
in the first process, setting a maximum value for the controlled variable; and/or
in the second process, setting the control value of the controlled variable to the maximum value when the target value of the at least one control variable is reached.

15. The method according to claim 1,
wherein the first process and/or the second process comprises at least one of the following:
a starting process of the analysis device, a system equilibration of the analysis device; and/or
wherein the first process is carried out experimentally and/or is simulated/modeled.

16. The method according to claim 1, wherein the first process serves as a reference, and a plurality of second processes are carried out based on the first process as the reference.

17. The method according to claim 1, wherein the analysis device comprises a thermostat and a separation column disposed in the thermostat, and the method is used for starting up the thermostat and the separation column.

18. An analysis device for carrying out an analysis, the analysis device comprising:
a control device configured to carry out the method according to claim 1.

19. The analysis device according to claim 18, further comprising:
a thermostat and a chromatographic separation column disposed in the thermostat; and
at least one of the following features:
wherein the first control variable comprises a flow rate of a mobile phase into the chromatographic separation column;
wherein the second control variable comprises the temperature of the thermostat;
wherein the controlled variable comprises the back pressure at the chromatographic separation column in response to a flow of the mobile phase with increasing temperature.

20. The analysis device according to claim 18, further comprising at least one of the following features:
the analysis device comprises a fluid drive configured to drive a mobile phase and a fluidic sample injected into the mobile phase;
the analysis device comprises a fluid drive configured to drive a mobile phase and a fluidic sample injected into the mobile phase at a pressure selected from the group consisting of: at least 500 bar; at least 1000 bar; and at least 1200 bar;
the analysis device comprises a sample separation apparatus configured to separate the fluidic sample injected into the mobile phase;
the analysis device is configured for analyzing at least one physical, chemical and/or biological parameter of the fluidic sample;
the analysis device is configured as a sample separation device for separating the fluidic sample;
the analysis device has a configuration selected from the group consisting of: a chromatography device; a liquid chromatography device; a gas chromatography device; a supercritical liquid chromatography device; and a high-performance liquid chromatography 5 device;
the analysis device is configured as a microfluidic device;
the analysis device is configured as a nanofluidic device;
the analysis device comprises one selected from the group consisting of: a sample separation unit; a chromatographic separation unit; and a chromatographic separation column;
the analysis device comprises a detector configured to detect the separated fluidic sample;
the analysis device comprises a fractionator configured to fractionate separated fractions of the fluidic sample.
